(19) United States
(12) Patent Application Publication
(10) Pub. No.: US 2018/0351859 A1
(43) Pub. Date: Dec. 6, 2018

(54) COMMUNICATION PATH CONTROL SYSTEM

(71) Applicant: MUFG Bank, Ltd., Tokyo (JP)

(72) Inventors: Takashi YAMAZAKI, Tokyo (JP); Fumihiro SATO, Tokyo (JP); Keitaro OTA, Tokyo (JP); Tatsuya KYOGOKU, Tokyo (JP)

(21) Appl. No.: 15/993,199

(22) Filed: May 30, 2018

(30) Foreign Application Priority Data
Jun. 2, 2017 (JP) 2017-110400
Sep. 19, 2017 (JP) 2017-179390

(51) Int. Cl. H04L 12/721; H04L 12/26

(52) U.S. Cl. CPC H04L 45/70; H04L 43/16

(57) ABSTRACT

A communication path control system includes a communication performance evaluation unit configured to evaluate communication performance of a network based on a number of SYN packets transmitted to a second communication device by a first communication device, and a path control unit configured to change a communication path of the first communication device to a third communication device from the second communication device in the case where a deterioration of communication performance of the second communication device is detected.

### CROSS REFERENCE TO RELATED APPLICATIONS

This application is based upon and claims the benefit of priority from the prior Japanese Patent Application No. 2017-110400, filed on Jun. 2, 2017, and No. 2017-179390, filed on Sep. 19, 2017, the entire contents of which are incorporated herein by reference.

### FIELD

An embodiment of the present invention is related to a communication path control system in a communication network system configured by mutually connecting a plurality of autonomous systems (AS).

### BACKGROUND

Generally, a network is configured by mutually connecting common policies and an AS which is a group of communication devices operated under the same environment. An identification number (AS number) is provided to each of the mutually connected AS's. In addition, BGP (Border Gateway Protocol) is used as a path control protocol to be used between the plurality of AS's.

When starting communication, a communication device which communicates by BGP establishes a one-to-one connection using TCP. A transmission source communication device transmits SYN packets and receives SYN/ACK packets from a transmission destination communication device. Following this, a TCP connection is established when the transmission destination communication device transmits ACK packets.

When the TCP connection is established, the transmission source communication device and the transmission destination communication device exchange basic information (OPEN message) of the BGP with each other. At this time, a BGP session is established. After the BGP session is established, the transmission source communication device and the transmission destination communication device exchange routing tables with each other. Following this, the transmission source communication device transmits a KEEPALIVE message and confirms the existence of the transmission destination communication device.

A method of using an alternative path and transmitting traffic has been proposed as a method to cope with the occurrence of communication fault in a network. For example, a method is disclosed in which an autonomous system dedicated to a spare path is added as an additional network which makes it redundant and transmission is performed using the additional network as a packet of an existing network (for example, Japanese Laid Open Patent No. 2009-147735).

### SUMMARY

A communication path control system in an embodiment according to the present invention includes a communication performance evaluation unit configured to evaluate communication performance of a network based on a number of SYN packets transmitted to a second communication device from a first communication device, and a path control unit configured to change a communication path of the first communication device to a third communication device from the second communication device in the case where a deterioration of communication performance of the second communication device is detected.

The communication path control system in an embodiment according to the present invention further includes a measurement unit in the communication performance evaluation unit configured to measure a number of the SYN packets.

The communication path control system in an embodiment according to the present invention further includes a calculation unit in the communication performance evaluation unit configured to calculate a change ratio based on a number of the SYN packets.

The communication path control system in an embodiment according to the present invention further includes a determination unit in the communication performance evaluation unit configured to determine whether the ratio change exceeds a predetermined threshold.

In the communication path control system in an embodiment according to the present invention, the path control unit includes a path attribute change unit configured to change a path attribute of the third communication device.

In the communication path control system in an embodiment according to the present invention, the path attribute is a weight attribute.

The communication path control system in an embodiment according to the present invention further includes a performance deterioration determination unit in the communication performance evaluation unit configured to evaluate whether a deterioration of the communication capabilities is permanent or temporary.

In the communication path control system in an embodiment according to the present invention, after a communication path of the first communication device is changed to the third communication device from the second communication device, in the communication performance evaluation unit, the communication path of the first communication device is changed to the second communication device from the third communication device in the case where it is determined that a deterioration of the communication performance has recovered.

A communication path control system in an embodiment according to the present invention includes a communication performance evaluation unit configured to evaluate communication performance of a network based on a SYN packet ratio of a first communication device with respect to a first communication device, and a path control unit configured to change a communication path of the first communication device to a third communication device from the second communication device in the case where a ratio change of the SYN packet is detected.

In the communication path control system in an embodiment according to the present invention, the ratio of the SYN packet is a ratio between a SYN packet transmitted from the first communication device to the second communication device, and a SYN/ACK packet transmitted from the second communication device to the first communication device.

In the communication path control system in an embodiment according to the present invention, the path control unit includes a path attribute change unit configured to change a path attribute of the third communication device.

In the communication path control system in an embodiment according to the present invention, the path attribute is a weight attribute.

In the communication path control system in an embodiment according to the present invention, a ratio of the SYN packets of the first communication device with respect to the second communication device is measured also after the communication path of the first communication device is changed to the third communication device from the second communication device.

In the communication path control system in an embodiment according to the present invention, after the communication path of the first communication device is changed to the third communication device from the second communication device, in the communication performance evaluation unit, the communication path of the first communication device is changed to the second communication device from the third communication device in the case where it is determined that a deterioration of the communication performance in the communication path has been deleted.

A communication path control system in an embodiment according to the present invention includes a communication performance evaluation unit configured to evaluate communication performance of a network based on a SYN packet ratio of a first communication device with respect to a second communication device, and a path control unit configured to change a communication path of the first communication device to a third communication device from the second communication device in the case where a ratio of the SYN packet is detected as exceeding 1.

In the communication path control system in an embodiment according to the present invention, the ratio of the SYN packet is a ratio between a SYN packet transmitted from the first communication device to the second communication device, and a SYN/ACK packet transmitted from the second communication device to the first communication device.

In the communication path control system in an embodiment according to the present invention, the path control unit includes a path attribute change unit configured to change a path attribute of the third communication device.

In the communication path control system in an embodiment according to the present invention, the path attribute is a weight attribute.

In the communication path control system in an embodiment according to the present invention, a ratio of the SYN packets of the first communication device with respect to the second communication device is measured also after the communication path of the first communication device is changed to the third communication device from the second communication device.

In the communication path control system in an embodiment according to the present invention, after the communication path of the first communication device is changed to the third communication device from the second communication device, in the communication performance evaluation unit, the communication path of the first communication device is changed to the second communication device from the third communication device in the case where it is determined that a ratio of the SYN packet is 1 over a fixed period of time.

The present invention can provide a communication path control system capable of switching to a detour path in the case when fault in communication performance of a communication device or deterioration in communication performance is detected in a network.

### BRIEF DESCRIPTION OF DRAWINGS

FIG. 1 is a diagram showing a structural example of a network related to a first embodiment;

FIG. 2 is a structural diagram showing a communication path control system related the first embodiment;

FIG. 3 is a graph representing a variation in the number of SYN packets in each time period;

FIG. 4 is a flowchart showing a process of a communication path control system related to the first embodiment;

FIG. 5. is a structural diagram showing a communication path control system related a second embodiment;

FIG. 6. is a diagram showing a structure example of a network related to a third embodiment;

FIG. 7 is a flowchart showing a process of a communication path control system related to the third embodiment; and

FIG. 8 is a block diagram of a communication path control system related to the third embodiment.

### DESCRIPTION OF EMBODIMENTS

The embodiments of the present invention are explained below while referring to the drawings and the like. However, the present invention can be practiced in many different modes and is not to be interpreted as being limited to the described content of the embodiments exemplified below. Although the drawings are sometimes represented schematically for clarity of explanation, they are merely examples and do not limit interpretation of the present invention. In addition, the letters “first” and “second” attached to each element are convenience signs used for distinguishing each element and do not have any other meaning unless otherwise specified. Furthermore, in the drawings referred to in the present embodiment, the same reference numerals or similar symbols are attached to the same parts or parts having similar functions, and repeated explanations thereof may be omitted. In addition, a part of the structure may be omitted from the drawings. Other than this, in the case where it can be recognized by a person with ordinary knowledge in the field to which the present invention belongs, no special explanation is provided.

### First Embodiment

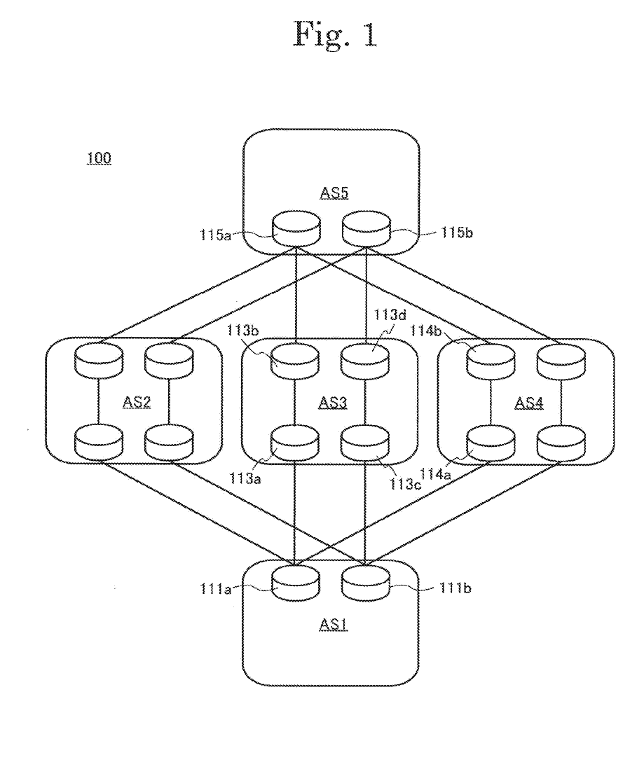

A communication path control system according to the present embodiment is explained while referring to FIG. 1 to FIG. 4.

FIG. 1 is a block diagram showing a structural example of a network 100 according to the present embodiment. The network 100 according to the present embodiment is configured by autonomous systems AS1 to AS5. The autonomous systems AS1 to AS5 configuring the network are mutually connected by communication devices corresponding to entrances and exits. In the present embodiment, a communication device 111a of the autonomous system AS1 uses a communication device 115a of the autonomous system AS5 to communicate with the communication device 115a via a communication device 113a and a communication device 113b of the autonomous system AS3 as a first communication path. In addition, a case is explained whereby the communication device 111a of the autonomous system AS1 makes a path for communicating with the communication device 115a of the autonomous system AS5 via the communication device 114a and the communication device 114b of the autonomous system AS4 as a second communication path.

Each of the communication devices 111a, 111b, 113a to 113d, 114a, 114b, 115a, and 115b of the autonomous systems AS1 to AS5 has a BGP communication function. BGP is distinguished by BGP used between different autonomous systems AS is called eBGP (external BGP), and BGP used within the same autonomous system AS is called iBGP (internal BGP). For example, eBGP is used for the communication device 111a of the autonomous system AS1 and the communication device 113a of the autonomous system AS3, and iBGP is used for the communication device 113a and the communication device 113b of the autonomous system AS3.

BGP establishes a one-to-one session using TCP when starting communication. For example, the transmission source communication device 111a transmits a SYN packet and receives a SYN/ACK packet from the transmission destination communication device 113a. After that, a session is established by the communication device 111a transmitting an ACK packet.

A method of configuring an alternative path and transmitting traffic has been proposed as a method to deal with the occurrence of communication fault in a network. For example, there is a method of adding an autonomous system dedicated to a spare path as an additional network to make it redundant and transmitting using the additional network as a packet of an existing network.

However, in the method described above, since the autonomous system dedicated to a spare path is added as an additional network, the number of communication devices increases. In addition, if the communication function of the communication device is completely stopped, it is possible to switch to the spare path as described above. However, no measures against temporary deterioration of communication performance such as when the communication function of the communication device is not completely stopped have been made.

Even in the case when the communication function of the communication device is not completely stopped, the packets continues to be transmitted to the communication device as usual. As a result, a problem occurs in which the communication device discards or breaks the packet.

The SYN packet used in TCP always exists in a series of data communication during the normal state of the network. For example, when the communication performance deteriorates between the communication device 111a and the communication device 113 a, the number of SYN packets per unit time tends to increase at once. Furthermore, in the present specification and the like, deterioration in communication performance includes not only a communication obstacle but also a decrease in communication speed.

Therefore, one embodiment of the present invention aims to provide a communication path control system which can switch to a detour path when an obstacle in communication performance of a communication device or deterioration in communication performance is detected.

In the communication path control system according to the present embodiment, the communication performance of the network is evaluated based on the number of SYN packets transmitted by the first communication device to the second communication device, and in the communication performance evaluation unit, in the case where deterioration of communication performance of the second communication device is detected, a process for changing the communication path of the first communication device from the second communication device to the third communication device is performed. That is, in the communication device 111a shown in FIG. 1, a process is performed for increasing the priority of the second communication path via the communication device 114a more than the first communication path via the communication device 113a. The first communication device, the second communication device, and the third communication device are explained below as the communication device 111a, the communication device 113a and the communication device 114a shown in FIG. 1.

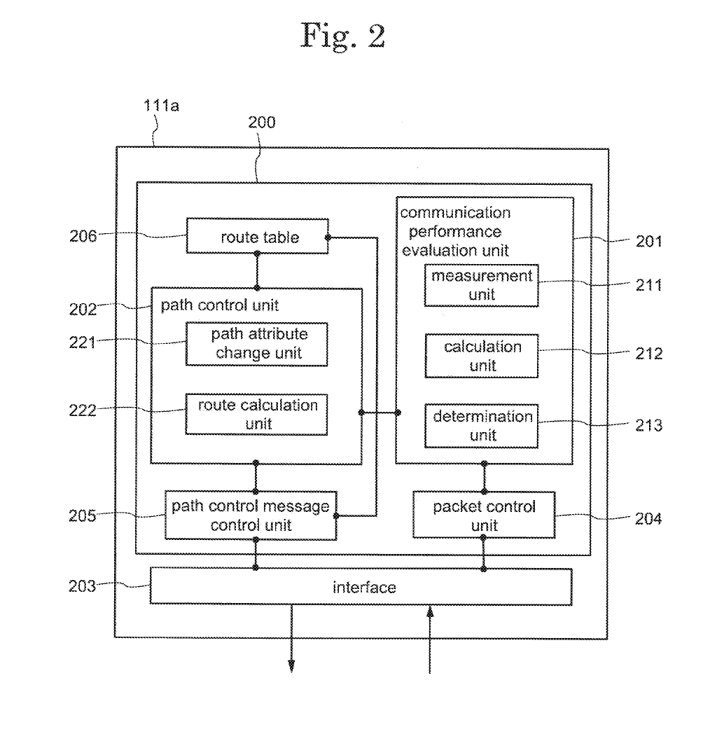

FIG. 2 shows a structural diagram of a communication path control system 200 according to the present embodiment. The communication path control system 200 according to the present embodiment can be mounted on a communication device such as a boundary edge router of an autonomous system communicating using eBGP, for example. In addition, in the present embodiment, an example is explained in which the communication path control system 200 is mounted on the communication device 111a shown in FIG. 1. Furthermore, since the communication path control system 200 according to the present embodiment may be a communication device that is connected to another communication device by BGP, the communication path control system 200 of the present embodiment can be mounted on each of the communication devices 111b, 113a-113d, 115a and 115b. In addition, the communication device 111a includes an interface 203 in addition to the communication path control system 200.

The communication path control system 200 includes at least a communication performance evaluation unit 201 and a path control unit 202. The communication path control system 200 further includes a packet control unit 204, a path control message control unit 205 and a routing table 206.

The communication performance evaluation unit 201 includes a measurement unit 211, a calculation unit 212, and a determination unit 213. In addition, the path control unit 202 includes a path attribute change unit 221 and a route calculation unit 222.

The interface 203 establishes a connection with an adjacent communication device and transmits/receives packets to and from an adjacent communication device. In addition, the packet control unit 204 transmits a SYN packet to the adjacent communication device via the interface 203 and receives a SYN/ACK packet and transmits an ACK packet. Furthermore, a SYN is a flag attached to the first packet requesting establishment of a TCP connection. In addition, ACK is a flag for response confirmation and is attached to all packets other than the connection request. In addition, SYN/ACK is obtained by setting both a SYN flag and ACK flag to 1. At the time of normal communication, the SYN/ACK packet is transmitted only when the SYN packet is received. In the case when deterioration or an obstacle occurs in communication performance, the SYN/ACK packet may not be transmitted from the adjacent communication device.

The path control message control unit 205 transmits and receives path control messages to and from adjacent communication devices via the interface 203. A communication device having a BGP function exchanges function information in a format called a message in order to establish a peer with a communication device in a different autonomous system AS. For example, the path control message may include an OPEN message, a KEEPALIVE message, or an UPDATE message and the like.

Here, the OPEN message is a message which is exchanged at the beginning of a BGP session. The KEEPALIVE message is a message which is exchanged at regular intervals to confirm that a peer has been established. The UPDATE message is a message which is used in the exchange of path information of BGP. They are transmitted in the case of an addition of a path when a deletion occurs.

The routing table 206 stores all paths information such as paths obtained or updated by a path control message or paths changed by the path control unit 202.

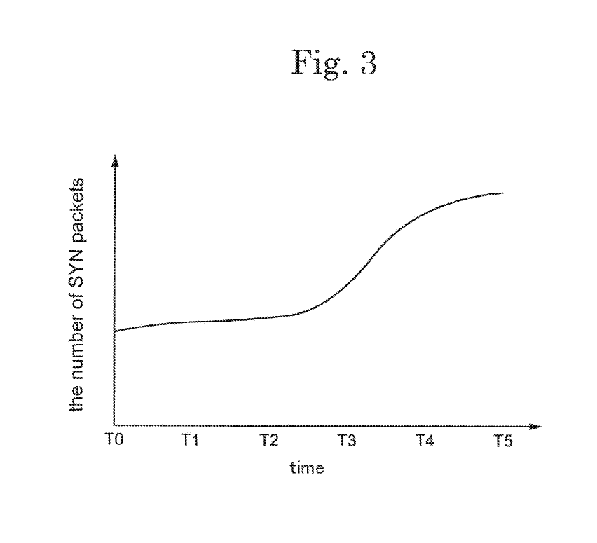

In the communication performance evaluation unit 201, the measurement unit 211 measures the number of SYN packets transmitted by the communication device 111a to the communication device 113a. FIG. 3 shows a graph expressing the variation in the number of SYN packets at each time period. In FIG. 3, the time period for measuring the number of SYN packets is from the time T1 to time T5. The number of measured SYN packets is transmitted to the calculation unit 212.

The calculation unit 212 calculates the ratio of change of the SYN packet for each time period based on the number of measured SYN packets. For example, in FIG. 3, the ratio of change in the number of SYN packets is calculated based on the measurement results of SYN packets at time T1 and time T2. The ratio of change of the calculated SYN packets is transmitted to the determination unit 213.

The determination unit 213 determines whether or not the ratio of change in the SYN packet exceeds a predetermined threshold value set in advance. In the case where it is determined that the threshold value has not been exceeded, it is determined that the communication performance has not deteriorated in the communication device 113a and the communication is maintained unchanged.

In the case when it is determined that the ratio of change of the SYN packet exceeds a predetermined threshold value set in advance, it is determined that the communication performance of the communication device 113a has deteriorated, and the path control unit 202 is notified.

In the case when the path control unit 202 detects deterioration of communication performance, it performs a process for changing from the first communication path to the second communication path (detour path). In the present embodiment, a process for changing the communication path of the communication device 111a from the communication device 113a to the communication device 114a is performed. That is, in the communication device 111a, a process is performed to increase the priority level of the second communication path via the communication device 114a more than the first communication path via the communication device 113a.

The process for changing the communication path of the communication device 111a from the communication device 113a to the communication device 114a is performed by changing a path attribute of the BGP. In BGP, all communication paths are compared based on the path attribute, and the optimum path to be used for routing is selected. Therefore, in the case of when a plurality of communication paths exist for the same destination, the path attributes of all the communication paths are compared, and the most suitable path for transferring traffic is determined. In BGP, communication paths are compared in order based on the following order of priorities.

1. Paths that do not have an IGP path to the next hop are ignored.
2. A router having a WEIGHT attribute selects a path having the largest WEIGHT attribute value. (WEIGHT attribute is a Cisco proprietary path attribute)
3. The path with the highest value of the LOCAL_PREF attribute selected.
4. The path with the shortest length of the AS_PATH attribute list is selected.
5. The path with the lowest type of ORIGIN attribute is selected.
(In the order IGP<EGP<INCOMPLETE)
6. When a path is acquired from the same AS and when a plurality paths exist, a path having a low value of the MULTI_EXIT_DISC attribute is prioritized.
7. The path acquired by eBGP rather than iBGP is prioritized.
8. The nearest path in IGP to the next hop is prioritized.
9. The path learned from a peer with the lowest router ID is prioritized.

Therefore, by changing the path attribute such as the WEIGHT attribute, the LOCAL_PREF attribute, the AS_PATH attribute and the ORIGIN attribute, it is possible to change the communication path from the communication device 111a to the communication device 115a. Here, a case where the WEIGHT attribute is changed as the path attribute is explained.

The WEIGHT attribute is a path attribute of a vendor definition (unique to Cisco) and is an attribute used only in the target communication device (communication device 111a) and is not transmitted to other communication devices. A value of “32768” is assigned by default to the communication path to which the communication device 111a is connected, and values of other paths are “0”. The WEIGHT attribute has a path prioritized with a large number.

Here, in the communication device 111a, a setting is made to increase the value of the WEIGHT attribute for the communication device 114a more than the value of the WEIGHT attribute for the communication device 113a. Furthermore, the WEIGHT value is used only within the communication device 111a, is not assigned to the UPDATE message and is also not notified to the adjacent autonomous system AS.

When the path attribute of the BGP is changed by the path attribute change unit 221, the path calculation unit 222 calculates the optimum path. As a result of the calculation, the communication path of the communication device 111a can be changed from the communication device 113a to the communication device 114a. That is, in the communication device 111a, a process is performed to increase the priority of the second communication path via the communication device 114a more than the first communication path via the communication device 113a. In this way, the changed communication path is stored in the routing table 206.

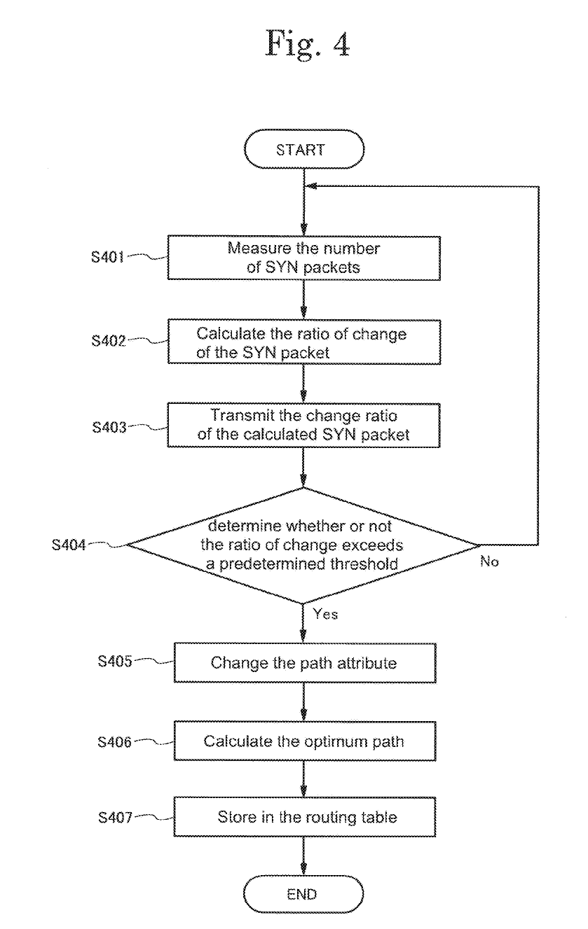

Next, a process performed by the communication path control system 200 according to the present embodiment is explained while referring to FIG. 2 and FIG. 4. FIG. 4 is a flowchart of processes in a communication path control system.

First, as shown in FIG. 4, the measurement unit 211 measures the number of SYN packets transmitted by the first communication device to the second communication device (step S401). Next, the calculation unit 212 calculates the ratio of change of the SYN packet corresponding to the time period based on the measurement result of the SYN packet (step S402).

Next, the change ratio of the calculated SYN packet is transmitted to the determination unit 213 (step S403). Next, the determination unit 213 determines whether or not the ratio of change exceeds a predetermined threshold set in advance (step S404). In the case when the ratio of change does not exceed the predetermined threshold set in advance (step S404; No), the process returns to step S401. In the case when the ratio of change exceeds a predetermined threshold set in advance (step S404; Yes), the path attribute of the first communication device is changed to the third communication device (step S405).

By changing the path attribute, the route calculation unit 222 calculates the optimum path from the communication device 111a to the communication device 115a (step S406). As a result of the calculation, in the communication device 111a, in the case when the priority of the second communication path via the communication device 114a a becomes higher than the priority of the first communication path via the communication device 113a, it is possible to change the communication path of the first communication device from the second communication device to the third communication device. That is, in the first communication device, it is possible to change from the first communication path via the second communication device to the second communication path via the third communication device. In this way, the changed communication path is stored in the routing table 206 (step S407).

According to the communication path control system of the present embodiment, it is possible to detect deterioration of the communication performance of the network. As a result, in the case when deterioration in communication performance is detected in the first communication path from the communication device 111a to the communication device 115a via the communication device 113a, it is possible to immediately switch to the second communication path (detour path) via the communication device 114a. In this way, it is possible to stabilize the communication performance of the network.

### Second Embodiment

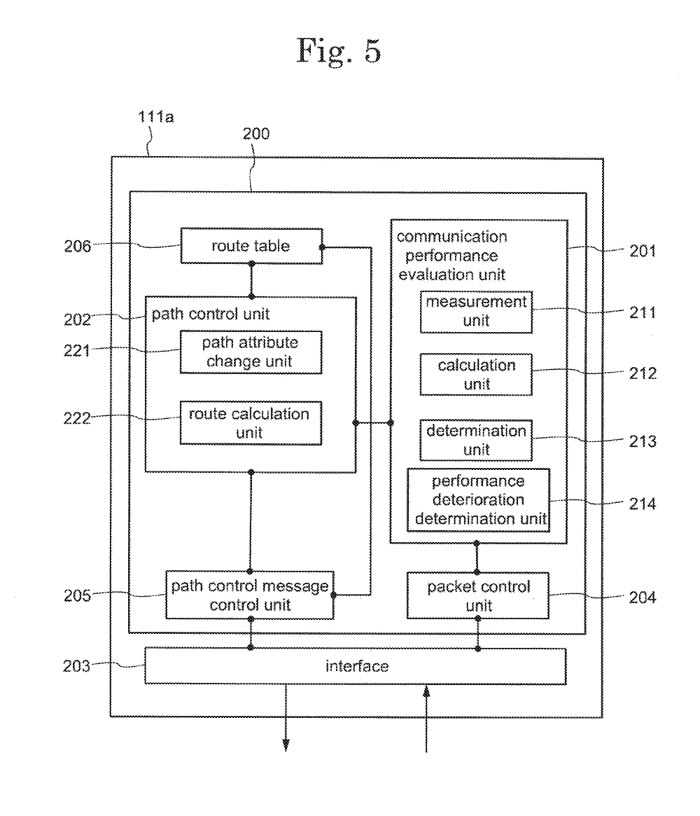

In the first embodiment, a process of immediately switching to the second communication path which is a detour path in the case when deterioration of communication performance is detected in the first communication path of the communication device 113a was explained. In the present embodiment, in the case when deterioration of communication performance of the communication device 113a is temporary, after changing to the second communication path which is a detour path via the communication device 114a, the case of returning to the first communication path which is the original communication path is explained while referring to FIG. 1 and FIG. 5.

The communication path control system according to the present embodiment includes a performance deterioration determination unit 214 in addition to the measurement unit 211, the calculation unit 212 and the determination unit 213 in the communication performance evaluation unit 201.

The performance deterioration determination unit 214 determines whether the deterioration of communication performance of the communication device 113a determined by the determination unit 213 is temporary or permanent. The performance deterioration determination unit 214 transmits the determined communication performance deterioration to the path control unit 202.

Here, the determination of the deterioration of the communication performance of the communication device 113a in the performance deterioration determination unit 214 may be made, for example, in the calculation unit 212 after the number of times that the change ratio of the SYN packet exceeds the predetermined threshold continues for a predetermined number of times, and in the case when it is lower than a predetermined threshold value, it is determined that the communication performance is temporarily deteriorated. Alternatively, when the number of times that the ratio of change of the SYN packet exceeds the predetermined threshold continues beyond a predetermined number in the calculation unit 212, it is determined that the communication performance is permanently deteriorated. Alternatively, in the case when the ratio of change of the SYN packet increases significantly in the calculation unit 212, it is not determined as a temporary deterioration of communication but is determined as permanent deterioration of communication performance as a result of Dos attack for example.

The path control unit 202 changes the method of changing the communication path according to the result of the determination of the deterioration of communication performance of the communication device 113a. In the case when the change ratio of the SYN packet exceeds a predetermined threshold value, in the communication device 111a, the path attribute for the communication device 113a and the path attribute for the communication device 114a are changed. For example, the WEIGHT value explained in the first embodiment is set higher for the communication device 114a than for the communication device 113a. Following this, the route calculation unit 222 calculates the optimum path. As a result of the calculation, the communication path of the communication device 111a can be changed from the communication device 113a to the communication device 114a. That is, in the communication device 111a, it is possible to change from the first communication path via the communication device 113a to the second communication path via the communication device 114a. In this way, the changed communication path is saved in the routing table 206.

Following this, in the case when the change ratio of the SYN packet is lower than a predetermined threshold value after the number of times the predetermined value is exceeded continues for a predetermined number of times, the performance deterioration determination unit 214 determines that the deterioration of the communication performance is temporary and transmits this determination result to the path control unit 202. The route control unit 202 again changes the path attribute for the communication device 113a and the path attribute for the communication device 114a. For example, the WEIGHT attribute of the communication device 111a with respect to the communication device 113a and the WEIGHT attribute value for the communication device 114a are returned to the values before changing to the detour path. In this way, it is possible to return from the detour path via the communication device 114a to the communication path via the communication device 113a. In addition, also in the case when the communication path is returned to its original state, it is stored in the routing table 206. Furthermore, the path attribute to be changed is not limited to a WEIGHT attribute and other path attributes may be changed.

In the communication path control system shown in the present embodiment, it is determined whether deterioration of communication performance is temporary or permanent. If deterioration of communication performance is temporary, it is possible to return to the original communication path after recovering from deterioration of communication performance by using the detour path. In this way, it is possible to stabilize the communication performance of the network.

### Third Embodiment

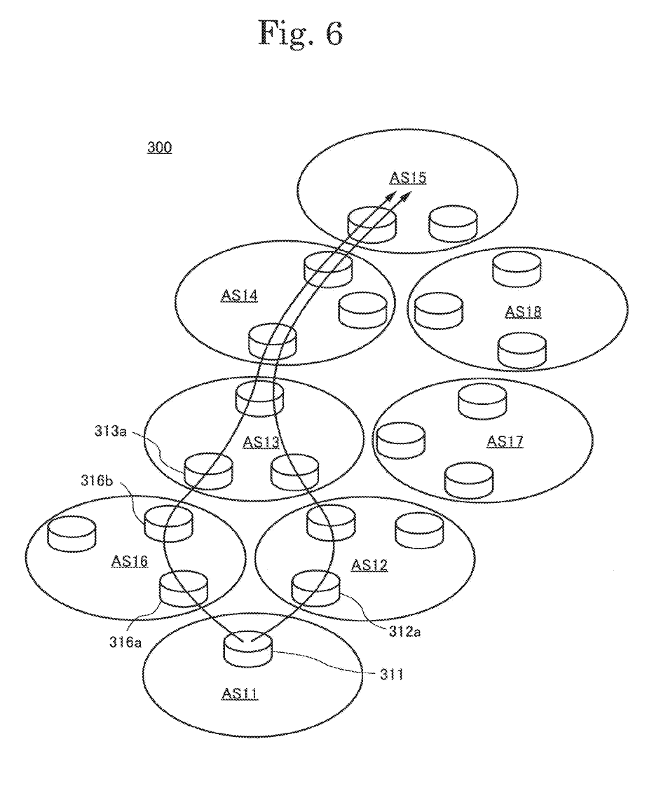

In the present embodiment, a communication path control system different from the previous embodiments is explained while referring to FIG. 6 to FIG. 8. In the present embodiment, an explanation is given of a method of immediately changing to the second communication path which is a detour path, in the case when deterioration or obstacles occurs in the communication performance on the first communication path but the obstacle sections cannot be specified. In addition, a method of returning from the second communication path to the original first communication path when deterioration of communication performance on the first communication path is resolved is explained.

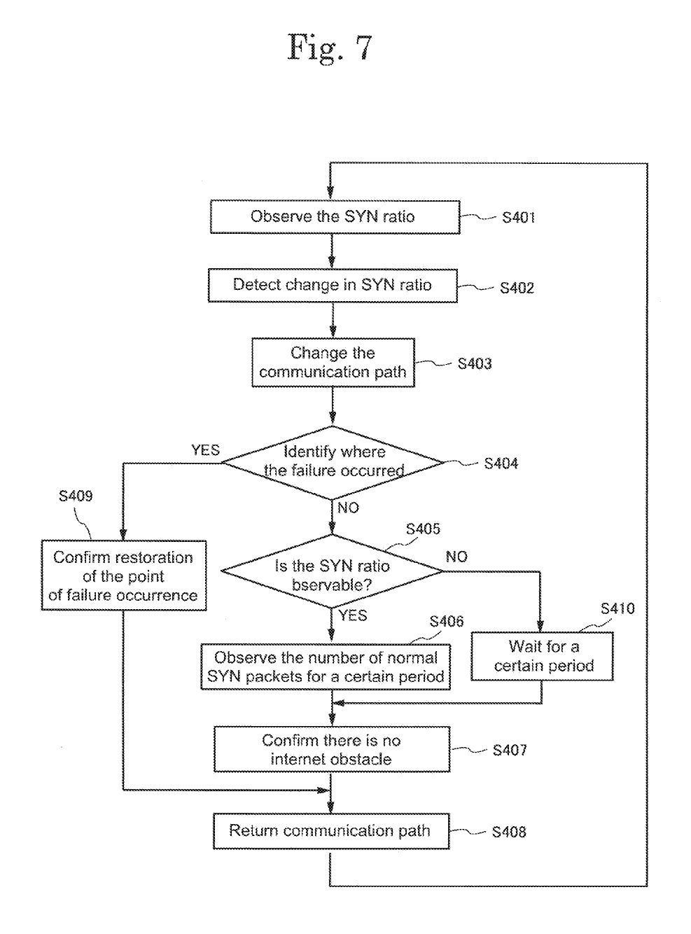

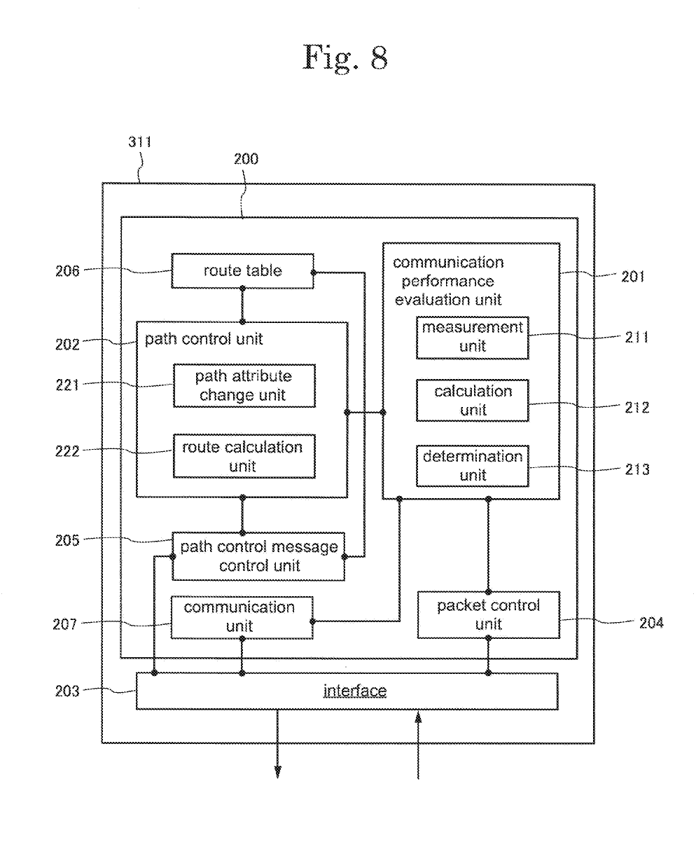

FIG. 6 is a diagram showing a structural example of a network 300 according to the present embodiment. FIG. 7 is a flowchart of the communication path control system according to the present embodiment. FIG. 8 is a block diagram of the communication path control system according to the present embodiment.

As shown in FIG. 6, the network 300 according to the present embodiment is configured by autonomous systems AS11 to AS18. In FIG. 6, the communication path control system 200 according to the present invention is mounted on the communication device 311 of the autonomous system AS11.

In the present embodiment, there are two communication paths from the autonomous system AS11 to the target autonomous system AS15. In addition, among the two communication paths, a path from the autonomous system AS11 to the target autonomous system AS15 via the autonomous system AS12, the autonomous system AS13, and the autonomous system AS14 is set as the first communication path. In addition, a path from the autonomous system AS11 to the target autonomous system AS15 via the autonomous system AS16, the autonomous system AS13, and the autonomous system AS14 is set as a second communication path.

In the case when a communication device having a function which has completely stopped exists in the first communication path, a new path is updated by the UPDATE message. Therefore, deterioration or obstacles do not occur in communication performance. However, in the case when a half-broken communication device exists in the first communication path, although it is possible to exchange the KEEPALIVE message or the UPDATE message, deterioration or obstacles occur in communication performance. Even if a packet is transmitted to a communication device in a half-broken state, since it is or broken, normal communication is no longer possible.

Next, since communication control messages such as the KEEPALIVE message and the UPDATE message are exchanged in a half-broken communication device, it is difficult to identify the location of the obstacle. In addition, when specifying the occurrence location of obstacles, although it is possible to specify the obstacle occurrence location by entering a ping command to the communication device, depending on the communication device, it may be set not to respond to the ping. In such a case, since it is not possible to specify the location where the obstacle occurs, it may take time to resolve the obstacle. Therefore, stable communication cannot be provided.

Therefore, in the present embodiment, a method of performing a process for quickly changing to a detour path even when an occurrence location of an obstacle in a communication path cannot be specified is explained. In addition, a process for returning to the original communication path in the case when an obstacle in the communication path is resolved is explained.

A process performed by the communication path control system 200 according to the present embodiment is explained while referring to the flowchart shown in FIG. 7. In the following explanation, it is assumed that a normal communication path uses the first communication path.

In the communication path control system 200 according to the present embodiment, the ratio of SYN packets in the first communication path is observed (step S401). Here, the ratio of the SYN packets is the ratio of the SYN packets transmitted from the first communication device to the second communication device and the SYN/ACK packets transmitted from the second communication device to the first communication device. Measuring the number of SYN packets and the number of SYN/ACK packets to calculate the ratio of SYN packets is called observation of the ratio of SYN packets. In the first communication path, there is no deterioration or obstacle in communication performance, and in a normal case, the ratio between the SYN packet and the SYN/ACK packet is 1.

In the first communication path, when a half-broken communication device exists, the ratio of the SYN packet changes in the first communication path (step S402). In the case when the ratio between the SYN packet and the SYN/ACK packet exceeds 1, for example, a communication device in a half-broken state exists in the first communication path.

Next, in the case when a change in the ratio between the SYN packet and the SYN/ACK packet is detected, a process is performed for changing from the first communication path to the second communication path as a detour path (step S403). The change of the communication path is made not by specifying an autonomous system via a process from the autonomous system AS11 reaching the target autonomous system AS15, but by changing the path attribute of the communication device 311 to the communication device 316a. Changing the path attribute is performed, for example, by performing a process for increasing the value of the WEIGHT attribute with respect to the communication device 316a in the communication device 311. By performing the process of increasing the value of the WEIGHT attribute, in the case when the priority of the second communication path via the communication device 316a becomes higher than the priority of the first communication path via the communication device 312a, a change is made from the first communication path to the second communication path.

Next, the obstacle occurrence location in the first communication path is specified (step S404). In the autonomous system AS12, the autonomous system AS13 and the autonomous system AS14 in the first path, which communication device has an abnormality is specified. By transmitting a ping command on each communication device on the first communication path where an obstacle has occurred in communication performance, it is possible to identify the obstacle occurrence location. If an echo request is transmitted to each communication device on the first communication path and an echo response is received, the ping command has been successful. However, in the case where an echo response cannot be received, since it is understood that an abnormality has occurred in that communication device, it is possible to be specified as an obstacle occurrence location.

On the other hand, in the case when there is a communication device that does not respond to a ping on the first communication path, or when there is a communication device in a half-broken state, an obstacle occurrence location cannot be specified. In such a case (step S404; NO), the process proceeds to step S405.

Furthermore, in the present embodiment, when the occurrence of an obstacle in communication performance or deterioration in communication performance is detected and when a change is made from the first communication path to the second communication path, the value of the WEIGHT attribute for the communication device 316a of the communication device 311 is changed. Although the value of the WEIGHT attribute is a value that is emphasized in the communication path determination process, it is a value which increases the priority of path selection, and is not a value for specifying and communicating with via an autonomous system. Therefore, via an autonomous system cannot be specified and communicated with.

Therefore, even in the case when a process for increasing the priority of the second communication path via the communication device 316a is performed, tan autonomous system the same as the first communication path may be passed through. For example, as shown in FIG. 6, in the first communication path, the target autonomous system AS15 is reached from the autonomous system AS11 via the autonomous system AS12, the autonomous system AS13, and the autonomous system AS14. In addition, in the second communication path, the target AS15 is reached from the autonomous system AS11 via the autonomous system AS16, the autonomous system AS13, and the autonomous system AS14. Therefore, the target AS15 is reached by the first communication path and the second communication path via the same autonomous system AS13 and autonomous system AS14.

Therefore, even after changing the path from the first communication path to the second communication path, the ratio of the SYN packet and SYN/ACK packet in the first communication path continues to be observed (step S405).

The ratio of the SYN packet and the SYN/ACK packet in the first communication path continues to be observed (step S406). The normal SYN packet and the SYN/ACK packet is observed for a certain period of time, the process proceeds to step S407. Observation of a normal SYN packet is a state in which the ratio between the SYN packet and the SYN/ACK packet is 1. Furthermore, immediately after changing from the first communication path to the second communication path, the number of SYN packets in the first communication path is greatly reduced. As a result, the accuracy of judging whether or not an obstacle occurs in the first communication path decreases. In addition, even when returning to the second communication path from the first communication path, in the case where an abnormality is immediately detected in the first communication path, it must be changed to the second communication path again. Therefore, it is necessary to confirm that the ratio between SYN packets and SYN/ACK packet is 1 for a certain time period in the first communication path. Here, the certain time period is about 1 hour to 2 hours.

Next, in the first communication path, it is confirmed that there is no report with respect to the occurrence of peer down, specification of an obstacle in the communication device and internet obstacle from the outside (step S407). Confirmation is carried out by a path control message (UPDATE message) with respect to the occurrence of peer down, specification of an obstacle in the communication device and internet obstacle from the outside.

Finally, when it is confirmed that there is no report regarding the occurrence of a peer down or the like in the first communication path, a process for returning from the second communication path to the first communication path is performed (step S408). The process of returning from the second communication path to the first communication path is a process of restoring the changed path attribute to the original state. For example, in the case of changing the value of the WEIGHT attribute, the value of the WEIGHT attribute is returned to its original value.

Following this, the ratio of the SYN packet and the SYN/ACK packet on the first communication path is continued to be observed (step S401).

Again, in the case when a change in the ratio between the SYN packet and the SYN/ACK packet is detected on the first communication path (step S402), the processes from step S403 to step S408 are performed.

Furthermore, in the case where it is possible to specify an obstacle occurrence location in the first communication path in step S404 (step S404; YES), then subsequently the recovery of the obstacle occurrence location is confirmed (step S409). Recovery of the obstacle occurrence location can be confirmed by the UPDATE message. Following this, a process for returning from the first communication path to the second communication path is performed (step S408).

In the case when the ratio between the SYN packet and the SYN/ACK packet cannot be observed in step S405, nothing is changed for a certain period of time (step S410). The period of time is, for example, about 1 hour to 2 hours. After a certain period of time elapses, the process proceeds to step S407. Following this, if there is no report on the occurrence of a peer down or the like, it is determined that there was a temporary defect and a process for returning from the second communication path to the first communication path is performed (step S408).

Following this, the ratio between the SYN packet and the SYN/ACK packet is observed again for a certain period of time (step S401), and if the ratio of the SYN packet is within 1, communication in the first communication path is continued.

According to the processes described above, in the case when the communication device 311 detects deterioration of communication performance in the first communication path, it can immediately change to the second communication path which is a detour path. In addition, in the case where deterioration of the communication performance is resolved in the first communication path, it is possible to return to the original first communication path from the second communication path which is a detour path. By performing the processes described above, stable communication can be provided.

Next, a block diagram of the communication path control system 200 according to the present embodiment is explained while referring to FIG. 8. Furthermore, the case where the communication path control system 200 according to the present embodiment is mounted on the communication device 311 is explained.

The communication performance evaluation unit 201 includes the measurement unit 211, the calculation unit 212, and the determination unit 213.

In the present embodiment, in the communication performance evaluation unit 201, the measurement unit 211 measures the number of SYN packets transmitted from the communication device 311 to the communication device 312a. In addition, the number of SYN/ACK packets transmitted from the communication device 312a to the communication device 311 is measured.

In addition, the calculation unit 212 calculates the ratio between the measured SYN packets and the SYN/ACK packets. The ratio of the calculated SYN packets is transmitted to the determination unit 213.

The determination unit 213 detects a change in the ratio of the SYN packets. In the case when the ratio of the SYN packets is 1, it is determined that communication performance has not deteriorated. On the other hand, in the case when the ratio of the SYN packets exceeds 1, it is determined that the communication performance has deteriorated.

In the case when it is determined that there is a change in the ratio of the SYN packets, it is determined that the communication performance of the communication device 311 has deteriorated, and the path control unit 202 and the communication unit 207 are notified.

In the case when the path control unit 202 detects deterioration of communication performance, it performs a process to change from the first communication path to the second communication path which is a detour path. In the present embodiment, a process performed to change the communication path of the communication device 311 from the communication device 312a to the communication device 316a.

In addition, in the case when deterioration of communication performance is detected, the communication unit 207 specifies the obstacle occurrence location in the communication path. As a method of specifying the location of the obstacle occurrence, a ping command is executed to all the communication devices on the communication path where an obstacle has occurred in communication performance, and the existence of the communication device is confirmed. The ping command is a command that uses an ICMP protocol, a response request is made to a device connected via a network and a response to the request is confirmed. If an echo request is transmitted to a communication device on the communication path and an echo response can be received, it is understood that there is no abnormality in the communication device. However, in the case where an echo response cannot be received, it is possible to specify the obstacle occurrence location assuming that there is an abnormality in the communication device. Here, in the case when the obstacle occurrence location cannot be specified, the communication performance evaluation unit 201 observes the ratio of the SYN packet in the first communication path.

The path control message control unit 205 receives a path control message relating to the BGP path information in a network, such as the occurrence of peer down, identification of a communication device in which an obstacle has occurred in the first communication path, or Internet obstacles and the like. In the network, when there is a change in the path information of the BGP, it is transmitted to the path table 206.

The communication path changed by the path control unit 202 and the path information received by the path control message (UPDATE message) is stored in the routing table 206.

According to the communication path control system according to the present embodiment, even if there is a communication device in which it is difficult to specify the location of an obstacle in the first communication path, it is possible to detect this as deterioration or an obstacle in communication performance and immediately change to the second communication path which is a detour path. In addition, in the case where deterioration or an obstacle of communication performance in the first communication path is resolved after the change to the second communication path, it is possible to return to the original first communication path from the second communication path. In this way, it is possible to provide stable communication.

Appropriate additions, deletions or design changes of constituent elements and processes performed by those skilled in the art based on the embodiments described above are also included in the scope of the present invention as long as they include the concept of the present invention.

What is claimed is:

1. A communication path control system comprising:
a communication performance evaluation unit configured to evaluate communication performance of a network based on a number of SYN packets transmitted to a second communication device from a first communication device; and
a path control unit configured to change a communication path of the first communication device to a third communication device from the second communication device in the case where a deterioration of communication performance of the second communication device is detected.

2. The communication path control system according to claim 1, further comprising:
a measurement unit in the communication performance evaluation unit configured to measure a number of the SYN packets.

3. The communication path control system according to claim 2, further comprising:
a calculation unit in the communication performance evaluation unit configured to calculate a change ratio based on a number of the SYN packets.

4. The communication path control system according to claim 3, further comprising:
a determination unit in the communication performance evaluation unit configured to determine whether the ratio change exceeds a predetermined threshold.

5. The communication path control system according to claim 4, wherein the path control unit includes a path attribute change unit configured to change a path attribute of the third communication device.

6. The communication path control system according to claim 5, wherein the path attribute is a weight attribute.

7. The communication path control system according to claim 6, further comprising:
a performance deterioration determination unit in the communication performance evaluation unit configured to evaluate whether a deterioration of the communication capabilities is permanent or temporary.

8. The communication path control system according to claim 7, wherein after a communication path of the first communication device is changed to the third communication device from the second communication device, in the communication performance evaluation unit, the communication path of the first communication device is changed to the second communication device from the third communication device in the case where it is determined that a deterioration of the communication performance has recovered.

9. A communication path control system comprising:
a communication performance evaluation unit configured to evaluate communication performance of a network based on a SYN packet ratio of a first communication device with respect to a first communication device; and
a path control unit configured to change a communication path of the first communication device to a third communication device from the second communication device in the case where a ratio change of the SYN packet is detected.

10. The communication path control system according to claim 9, wherein the ratio of the SYN packet is a ratio between a SYN packet transmitted from the first communication device to the second communication device, and a SYN/ACK packet transmitted from the second communication device to the first communication device.

11. The communication path control system according to claim 10, wherein the path control unit includes a path attribute change unit configured to change a path attribute of the third communication device.

12. The communication path control system according to claim 11, wherein the path attribute is a weight attribute.

13. The communication path control system according to claim 12, wherein a ratio of the SYN packets of the first communication device with respect to the second communication device is measured also after the communication path of the first communication device is changed to the third communication device from the second communication device.

14. The communication path control system according to claim 13, wherein after the communication path of the first communication device is changed to the third communication device from the second communication device, in the communication performance evaluation unit, the communication path of the first communication device is changed to the second communication device from the third communication device in the case where it is determined that a deterioration of the communication performance in the communication path has been deleted.

15. A communication path control system comprising:
a communication performance evaluation unit configured to evaluate communication performance of a network based on a SYN packet ratio of a first communication device with respect to a second communication device; and
a path control unit configured to change a communication path of the first communication device to a third communication device from the second communication device in the case where a ratio of the SYN packet is detected as exceeding 1.

16. The communication path control system according to claim 15, wherein the ratio of the SYN packet is a ratio between a SYN packet transmitted from the first communication device to the second communication device, and a SYN/ACK packet transmitted from the second communication device to the first communication device.

17. The communication path control system according to claim 10, wherein the path control unit includes a path attribute change unit configured to change a path attribute of the third communication device.

18. The communication path control system according to claim 17, wherein the path attribute is a weight attribute.

19. The communication path control system according to claim 18, wherein a ratio of the SYN packets of the first communication device with respect to the second communication device is measured also after the communication path of the first communication device is changed to the third communication device from the second communication device.

20. The communication path control system according to claim 19, wherein after the communication path of the first communication device is changed to the third communication device from the second communication device, in the communication performance evaluation unit, the communication path of the first communication device is changed to the second communication device from the third communication device in the case where it is determined that a ratio of the SYN packet is 1 over a fixed period of time.
